(19) United States
(12) Patent Application Publication
(10) Pub. No.: US 2023/0311915 A1
(43) Pub. Date: Oct. 5, 2023

(54) ELECTRIFIED VEHICLE AND METHOD FOR CONTROLLING ELECTRIFIED VEHICLE IN ACCORDANCE WITH MEDIA

(71) Applicants: Hyundai Motor Company, Seoul (KR); Kia Corporation, Seoul (KR)

(72) Inventor: Hui Un Son, Suwon (KR)

(21) Appl. No.: 18/071,973

(22) Filed: Nov. 30, 2022

(30) Foreign Application Priority Data
Apr. 4, 2022 (KR) 10-2022-0041687

(51) Int. Cl. B60W 50/14; B60W 60/00; B60W 40/10

(52) U.S. Cl. CPC B60W 50/14; B60W 40/10; B60W 60/001; B60W 2050/146

(57) ABSTRACT

An electrified vehicle according to an embodiment of the present disclosure includes an electrification control unit that analyzes media factors reproduced in the electrified vehicle, classifies the media factors into one or more control signals based on analyzed result values, and controls the electrified vehicle in connection with the one or more classified control signals when an autonomous driving mode is activated.

### CROSS REFERENCE TO RELATED APPLICATIONS

This application claims the benefit of Korean Patent Application No. 10-2020-0041687, filed on Apr. 4, 2022, which is hereby incorporated by reference in its entirety.

### BACKGROUND

### Field of the Disclosure

The present disclosure relates to an electrified vehicle capable of realizing a 4D function by operating various devices of the vehicle in connection with media when an autonomous driving mode is activated, and a method for controlling the electrified vehicle in accordance with media.

### Background

An autonomous vehicle refers to a vehicle that can travel without driver or passenger manipulation, and an automated vehicle & highway system refers to a system that monitors and controls such an autonomous vehicle such that it can travel by itself.

If an autonomous vehicle stably travels, a driver need not operate the vehicle and thus can watch movies or play games in the vehicle instead of driving.

In other words, when the era of fully autonomous driving arrives, it is necessary to provide a richer mobility experience to drivers.

### SUMMARY OF THE DISCLOSURE

An object of the present disclosure is to provide an electrified vehicle capable of realizing a 4D function by operating various devices of the vehicle in connection with media to provide a richer mobility experience to users when the autonomous driving mode is activated, and a method for controlling the electrified vehicle in accordance with media.

It will be appreciated by persons skilled in the art that the object that could be achieved with the present disclosure is not limited to what has been particularly described hereinabove and the above and other objects that the present disclosure could achieve will be more clearly understood from the following detailed description.

An electrified vehicle of an embodiment of the present disclosure comprises an electrification control unit for an electrified vehicle. The electrification control unit may be configured to analyze media factors of a media content played in the electrified vehicle, classifies the media factors into one or more control signals based on analyzed result values, and control the electrified vehicle in connection with the one or more classified control signals during an autonomous driving mode.

The one or more control signals may include a first control signal related to motion of the electrified vehicle, a second control signal related to air conditioning, and a third control signal related to at least one of: seats, interior lights, and/or a washer fluid ejector.

The electrification control unit may include a motion determination unit configured to control a motion device of the electrified vehicle according to the first control signal, an air conditioning control unit configured to control an air conditioning device of the electrified vehicle according to the second control signal, and an auxiliary control unit configured to control at least one of the seats, the interior lights, and/or the washer fluid ejector according to the third control signal.

The motion determination unit may be configured to control the motion device to set vibration differently based on the first control signal.

The vibration may include a sine wave, a triangular waves or a square wave, and at least one of a period, an amplitude, a pulse width, and/or a waveform of the sine wave. In some embodiments, the triangular wave or the square wave may be set based on the first control signal.

The electrification control unit may control one or more of the motion determination unit, the air conditioning control unit, and/or the auxiliary control unit simultaneously or sequentially.

As an exemplary embodiment of the present disclosure, a method for controlling an electrified vehicle which comprises an electrification control unit may include determining whether the electrified vehicle is in an autonomous driving mode, analyzing media factors of a media content played in the electrified vehicle and classifying the media factors into one or more classified control signals based on analyzed result values, and controlling the electrified vehicle in connection with the one or more classified control signals during the autonomous driving mode.

In at least one embodiment of the method, the one or more control signals may include a first control signal related to motion of the electrified vehicle, a second control signal related to air conditioning, and a third control signal related to at least one of seats, interior lights, and/or a washer fluid ejector.

In at least one embodiment of the method, the controlling of the electrified vehicle step may further comprise controlling a motion device of the electrified vehicle according to the first control signal, controlling an air conditioning device of the electrified vehicle according to the second control signal, and controlling at least one of the seats, the interior lights, and/or a washer fluid ejector according to the third control signal.

In at least one embodiment of the method, the controlling of the motion device step may further include controlling the motion device to set vibration differently based on the first control signal.

In at least one embodiment of the method, the vibration may include a sine wave, a triangular waves or a square wave, and at least one of: a period, an amplitude, a pulse width, and a waveform of the sine wave. In various embodiments, the triangular wave or the square wave may be set based on the first control signal.

In at least one embodiment of the method, the controlling of the motion device step may further include controlling one or more of the motion determination unit, the air conditioning control unit, and/or the auxiliary control unit simultaneously or sequentially.

As an exemplary embodiment of the present disclosure, a non-transitory computer-readable recording medium may include a program containing computer executable code thereon for executing at least one of the methods described above.

The electrified vehicle and the method for controlling the electrified vehicle in accordance with media according to an embodiment of the present disclosure, configured as above, can implement a 4D function by operating various devices of the vehicle in connection with media when the autonomous driving mode is activated to provide a richer mobility experience to users.

It will be appreciated by persons skilled in the art that the effects that can be achieved with the present disclosure are not limited to what has been particularly described hereinabove and other advantages of the present disclosure will be more clearly understood from the following detailed description.

### BRIEF DESCRIPTION OF THE DRAWINGS

FIG. 1 shows an example of a configuration of an electrified vehicle applicable to embodiments of the present disclosure.

FIG. 2 is a block diagram showing an example of a control system of the electrified vehicle applicable to embodiments of the present disclosure.

FIG. 3 is a diagram showing an example of a configuration of an electrified vehicle according to an embodiment of the present disclosure.

FIGS. 4 to 6 are diagrams illustrating changing vibration to correspond to a media factor according to an embodiment of the present disclosure.

FIG. 7 is a flowchart showing an operation flow of an electrification control unit according to an embodiment of the present disclosure.

FIG. 8 is a diagram for describing an example of controlling the electrification control unit according to an embodiment of the present disclosure.

FIG. 9 is a diagram for describing another example of controlling the electrification control unit according to an embodiment of the present disclosure.

FIG. 10 is a diagram for describing another example of controlling the electrification control unit according to an embodiment of the present disclosure.

FIG. 11A and FIG. 11B are diagrams for describing another example of controlling the electrification control unit according to an embodiment of the present disclosure.

FIG. 12A and FIG. 12B are diagrams for describing another example of controlling the electrification control unit according to an embodiment of the present disclosure.

### DETAILED DESCRIPTION OF THE DISCLOSURE

The detailed description of the exemplary embodiments of the present disclosure will be given to enable those skilled in the art to implement and practice the disclosure with reference to the attached drawings. However, the present disclosure can be implemented in various different forms and is not limited to embodiments described herein. In addition, parts that are not related to description will be omitted for clear description in the drawings, and the same reference numbers will be used throughout this specification to refer to the same or like parts.

Throughout the specification, when it is said that some part “includes” a specific element, this may mean that the part may further include other elements, not excluding the same, unless mentioned otherwise. In addition, to the extent possible, the same or similar elements are designated by the same reference numerals throughout the specification.

Also, the term “electrified vehicle” means a vehicle which is capable to be driven by electricity alone or a combination of electricity and an internal combustion engine. For example, the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

In addition, a unit or a control unit included in names such as an electrification control unit (ECU) is only a term widely used in naming of a controller that controls a specific vehicle function and does not imply a generic functional unit. For example, each controller may include a communication device that communicates with other controllers or sensors to control the function thereof, a memory that stores an operating system, logic commands and input/output information, and one or more processors that perform determination, calculation, and decision necessary to control the function of the controller. Although example embodiments are described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

According to an embodiment of the present disclosure, when an autonomous driving mode or a car camping mode is activated, a vehicle is controlled to implement a 4D function by operating various devices of the vehicle in connection with media.

The autonomous driving mode can be defined as a state in which a vehicle becomes autonomous and moves by itself without human intervention. For example, an electrified vehicle can be implemented through linkage of complex networks of sensors and cameras which reproduce external environments of the machine for complete autonomous driving. For example, information collected from cameras, LiDAR, radar, and ultrasonic sensors is processed, and a vehicle is informed of distances to nearby objects, curb lane markings, traffic signals, and visual information of pedestrians. Processed information collected in this manner may be input to AI which makes a decision and controls the vehicle.

The car parking mode may be defined as a state in which a vehicle is parked in a predetermined place and a user stays in the parked vehicle.

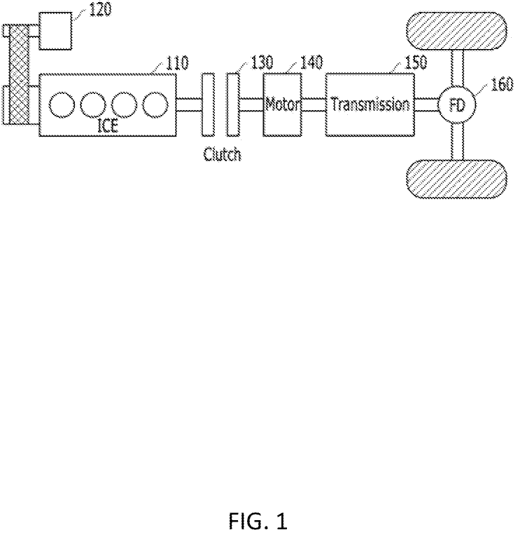

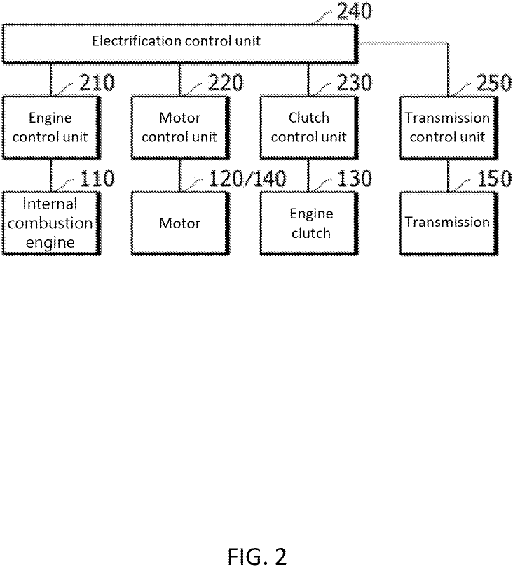

Before describing a media control method of an electrified vehicle according to an embodiment of the present disclosure, a structure and a control system of an electrified vehicle applicable to embodiments will be described with reference to FIGS. 1 and 2. It is apparent to those skilled in the art that a vehicle structure which will be described below with reference to FIGS. 1 and 2 can be similarly applied to an electric vehicle (EV), except for parts related to an internal combustion engine.

FIG. 1 shows an example of a configuration of an electrified vehicle applicable to embodiments of the present disclosure.

Referring to FIG. 1, the electrified vehicle according to an embodiment of the present disclosure may include a parallel type or transmission mounted electric drive (TMED) electrification power train having an electric motor (or a driving motor) 140 and an engine clutch (EC) 130 provided between an internal combustion engine (ICE) 110 and a transmission 150. The electrified powertrain may include a hybrid powertrain.

In such a vehicle, in general, when a driver depresses the accelerator after starting, the (driving) motor 140 (or driving motor) operates first using the power of a battery 170 while the engine clutch 130 is open, and the power of the motor 140 is transmitted to the transmission 150 and a final reducer (FD) 160 to move wheels (i.e., EV mode). When the vehicle is gradually accelerated and a greater driving force is required, a starter generator motor 120 may operate to drive the engine 110.

Accordingly, when the rotation speeds of the engine 110 and the motor 140 become substantially the same, the engine clutch 130 is engaged and the engine 110 and the motor 140 together or the engine 110 drives the vehicle (i.e., transition from the EV mode to an HEV mode). If preset engine off conditions are satisfied, such as when the vehicle is decelerated, the engine clutch 130 is opened and the engine 110 is stopped (i.e., transition from the HEV mode to the EV mode). Further, in the electrified vehicle, the battery 170 can be charged by converting the driving force of the wheels into electric energy during braking, which is referred to as braking energy regeneration or regenerative braking.

The starter generator motor 120 serves as a starter motor when the engine 110 is started, and operates as a generator when the engine 110 recovers rotational energy after the start or when the start is off, and thus may be referred to as a “hybrid starter generator (HSG) or an electric starter generator” and in some cases, may also be referred to as an “auxiliary motor”.

FIG. 2 is a block diagram showing an example of a control system of the electrified vehicle applicable to embodiments of the present disclosure. The control system shown in FIG. 2 may be applied to a vehicle to which the powertrain described above with reference to FIG. 1 is applied.

Referring to FIG. 2, in the electrified vehicle to which embodiments of the present disclosure are applicable, the internal combustion engine 110 may be controlled by an engine control unit 210, torques of the starter generator motor 120 and the driving motor 140 may be controlled by a motor control unit (MCU) 220, and the engine clutch 130 may be controlled by a clutch control unit 230. Here, the engine control unit 210 is also referred to as an engine control system (EMS).

In addition, the transmission 150 is controlled by a transmission control unit 250. In some cases, separate control units for the starter generator motor 120 and the driving motor 140 may be provided.

Each control unit may be connected to an electrification control unit (ECU) 240 that controls the overall mode conversion process as a higher control unit, and may provide information necessary for driving mode change and engine clutch control during gear shifting and/or information necessary for engine stop control to the electrification control unit 240 according to control of the electrification control unit 240 or perform an operation according to a control signal. The electrification control unit 240 may be referred to as a hybrid controller unit (HCU).

For example, the electrification control unit 240 may perform overall powertrain control in driving the vehicle. For example, the electrification control unit 240 may determine an open timing of the engine clutch 130. In addition, the electrification control unit 240 may determine the state (lockup, slip, open, or the like) of the engine clutch 130 and control a fuel injection stop timing of the engine 110. Further, the electrification control unit 240 may transmit a torque command for controlling the torque of the starter generator motor 120 to the motor control unit 220 for engine stop control to control engine rotational energy recovery.

In addition, when the autonomous driving mode or the car camping mode is activated, the electrification control unit 240 may control various devices of the vehicle to operate in connection with media to implement a 4D function, thereby providing a richer mobility experience to the user.

Of course, it is apparent to those skilled in the art that the above-described connection relationship between control units and the function/classification of each control unit are exemplary and are not limited by their names. For example, the electrification control unit 240 may be implemented such that the function thereof is provided by any one of the other control units, or the corresponding function may be distributed and provided by two or more of the other control units.

Hereinafter, an electrified vehicle and a media control method therefor according to an embodiment of the present disclosure will be described on the basis of the above-described vehicle or vehicle structure. Of course, it is apparent to those skilled in the art that the above-described connection relationship between a plurality of control units and the function/classification of each control unit are exemplary and are not limited by their names.

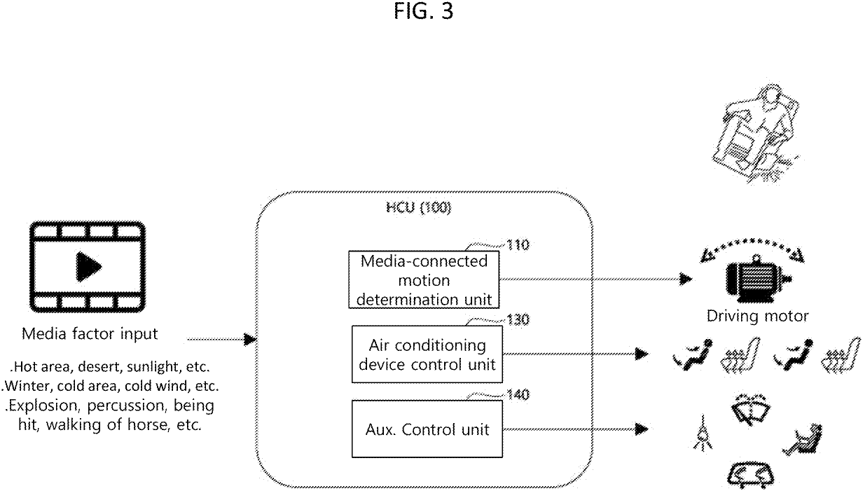

FIG. 3 is a block diagram showing an example of a configuration of an electrification control unit according to an embodiment of the present disclosure.

Referring to FIG. 3, upon determining that the autonomous driving mode is activated, the electrification control unit 240 may analyze media factors reproduced in the electrified vehicle and classify the media factors into one or more control signals on the basis of analyzed result values. That is, while the autonomous driving mode is activated, the electrification control unit 240 may analyze the media factors reproduced in the electrified vehicle and perform control such that a 4D function is implemented in connection with various devices of the vehicle on the basis of analyzed result values. The various devices of the vehicle may include a motion device, an air conditioning device, an additional device, and the like. The motion device may include at least one driving motor or various motors provided in an electrified vehicle.

The one or more control signals may include first to third control signals. A control signal may be referred to as a 4D control signal.

In addition, the electrification control unit 240 may be pre-processed before analyzing the media factors. For example, a motion determination unit 241 may perform filtering to remove background noise or the like before identifying audio or video properties.

According to an embodiment of the present disclosure, the electrification control unit 240 may include the motion determination unit 241, an air conditioning control unit 242, and an auxiliary control unit 243.

When the first control signal is provided under the control of the electrification control unit 240, the motion determination unit 241 may control the motion device. The motion determination unit 241 may set vibration differently by controlling the motion device on the basis of the first control signal. The first control signal may be a signal obtained by extracting properties related to motion control from media factors.

The motion determination unit 241 may set vibration differently by controlling the motion device on the basis of the first control signal. For example, vibration may include, without being limited to, a period, an amplitude, a pulse width, a waveform, a frequency envelope, an interval, peaks, and the like.

The motion determination unit 241 may generate various tactile types by setting different vibrations in response to the first control signal. The motion determination unit 241 may be referred to as a media-connected motion determination unit 241.

For example, the motion determination unit 241 may provide strong haptic feedback to a driver by decreasing the period when a remaining time for arrival of an event is reduced, a degree of urgency/importance is high, a degree of need for correction is high, or the driver sets strong haptic response. For example, at the time of guiding inertia driving, the motion determination unit 241 may provide strong feedback to the driver by performing guiding initially with a long period and decreasing the period as an inertia driving event section approaches. For example, the motion determination unit 241 may perform control such that tactile sensation with respect to heat, walking/moving, explosion, feeling nauseous, or the like is generated using various periods.

Here, haptics may be defined as technology for allowing a user to feel tactile sensation by generating vibration, force, or shock through various devices. Haptics can give users reality and accuracy, while reducing a malfunction rate and increasing operation efficiency. Vibrations can create different types of tactile sensations by varying in amplitude, frequency, and transmission time.

In addition, the motion determination unit 241 may increase an amplitude as the influence of an object (character, or the like) according to media factors increases. For example, the motion determination unit 241 may perform control such that tactile sensation with respect to percussion, being hit, cold, explosion, or the like is generated by using the amplitude.

In addition, the motion determination unit 241 may use a pulse width in various manners in such a manner that it can increase the pulse width as the influence of an object (character, or the like) according to media factors increases. For example, the motion determination unit 241 may perform control such that tactile sensation with respect to percussion, being hit, explosion, or the like is generated by using the pulse width.

In addition, the motion determiner 241 may control generation of tactile sensations with respect to heat/cold, percussion/being hit, feeling nauseous, walking/moving, and the like using various waveforms. For example, waveforms may include a sine wave, a triangular wave, a square wave, and the like. For example, the motion determination unit 241 may express heat, feeling nauseous, walking/moving, and the like using sine waves. The motion determination unit 241 may express severe cold or strong wind using triangular waves. In addition, the motion determination unit 241 may express percussion or being hit using square waves.

The motion determination unit 241 may generate various waveforms, periods, amplitudes, pulse widths, and the like by controlling the motion device of the vehicle to operate in connection with media factors under the control of the electrification control unit 240 to change vibration. The motion determination unit 241 may cause the driver to feel at least one tactile sensation by transmitting various waveforms, periods, amplitudes, pulse widths, and the like generated under the control of the electrification control unit 240.

When the second control signal is provided under the control of the electrification control unit 240, the air conditioning control unit 242 may control the air conditioning device. The second control signal may be a signal obtained by extracting properties related to air conditioning control from media factors. The air conditioning device may be a device for controlling the internal temperature of the electrified vehicle. The air conditioning control unit 242 may be referred to as an air conditioning device control unit.

For example, the air conditioning control unit 242 may identify media factors and classify the same into severe heat/heat/severe cold/cold/normal. That is, the air conditioning control unit 242 may correct the temperature of the air conditioning device by a preset amount from a temperature set by the driver on the basis of the second control signal.

For example, the air conditioning control unit 242 may identify a media factor and classify the same as +5 to +7° C. in case of severe heat, +2 to +5° C. in case of heat, -7 to -5° C. in case of severe cold, and -5 to -2° C. in in case of cold. Accordingly, the air conditioning control unit 242 may perform control such that a heated sheet operates in case of severe heat and a ventilation sheet operates in case of severe cold.

In addition, the air conditioning control unit 242 may identify media factors and classify the same into high air flow/low air flow/no air flow. For example, the air conditioning control unit 242 may increase an air flow rate of the air conditioning device by a preset correction amount from a value set by the driver on the basis of the second control signal.

For example, the air conditioning control unit 242 may identify a media factor and classify the same as 2 to 5 stages in case of a high air flow and 1 to 2 stages in case of low air flow.

In addition, the air conditioning control unit 242 may identify a media factor and operate the wiper in case of rain or the like. For example, the air conditioning control unit 242 may control the wiper on the basis of the second control signal. Specifically, the air conditioning control unit 242 may operate the wiper rapidly in case of a large amount of rain and operate the wiper slowly in case of a small amount of rain.

When the third control signal is provided under the control of the electrification control unit 240, the auxiliary control unit 243 may control the additional device. The third control signal may be a signal obtained by extracting properties related to additional control from media factors. The additional device may be a device for controlling seats, interior lights, a washer fluid ejector, and the like provided inside the vehicle. The auxiliary control unit 243 may be referred to as AUX, a control unit, an additional control unit, or an additional device control unit.

For example, the auxiliary control unit 243 may identify a media factor and control the washer fluid ejector to be sprayed if the media factor is an odor factor such as gunpowder. The auxiliary control unit 243 may control the washer fluid ejector to be sprayed along with operation of the wiper. That is, upon sensing spraying of the washer fluid ejector according to the auxiliary control unit 243, the electrification control unit 240 may control the wiper to operate by providing a predetermined signal to the air conditioning control unit 242.

Further, the auxiliary control unit 243 may perform control such that spraying of the washer fluid ejector stops depending on a driving environment. For example, in case of rain, the auxiliary control unit 243 may stop control when the amount of stored washer fluid ejector is equal to or less than a threshold value, and for a preset threshold time after the washer fluid ejector is sprayed.

In addition, the auxiliary control unit 243 may identify media factors, classify the media factors according to postures or locations of media entities, and perform control such that the angle of a sheet is adjusted based thereon.

For example, the auxiliary control unit 243 may control the angle of a sheet to be raised by a preset value if an identified media factor is classified as a factor representing tension felt at the time of encountering a cliff, for example. When an identified media factor is classified as a factor representing calmness felt at the time of ending driving or staying in a peaceful trailer, for example, the auxiliary control unit 243 may control the angle of the seat to be lowered.

In addition, the auxiliary control unit 243 may identify a media factor and control the interior lights when the media factor represents heat, glare, dazzling, or the like.

For example, if an identified media factor is classified as a factor representing heat, the auxiliary control unit 243 may control the interior lights to be always be on. The auxiliary control unit 243 may prohibit control of the interior lights depending on a driving environment. For example, when sensed external illuminance is equal to or greater than a preset threshold value, the auxiliary control unit 243 may prohibit control of the interior lights.

The auxiliary control unit 243 may control the interior lights to blink periodically when an identified media factor represents dazzling, glare, or the like.

As described above, the electrification control unit 240 may control one or more of the motion determination unit 241, the air conditioning control unit 242, and the auxiliary control unit 243 simultaneously or sequentially to implement a 4D function, thereby providing richer and more diverse tactile and a mobility experience to a driver.

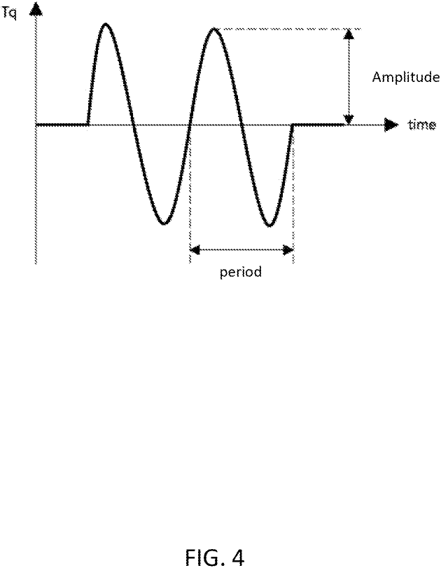

FIGS. 4 to 6 are diagrams illustrating changing vibration to correspond to media factors according to an embodiment of the present disclosure.

In FIGS. 4 to 6, the horizontal direction (X direction) represents the lapse of time and the vertical direction (Y direction) represents a torque.

As shown in FIG. 4, the electrification control unit may control various devices of the vehicle in connection with media factors to change the amplitude and the period of a waveform such that a driver feels tactile sensations with respect to heat, walking/moving, explosion, feeling nauseous, and the like. For example, various devices of the vehicle may include a motion device (e.g., a driving motor 140 as shown in FIG. 1), an air conditioning device, and an additional device. The waveform may be a sine wave.

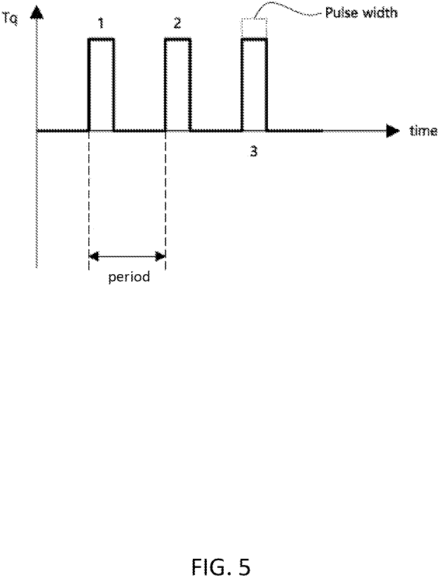

As shown in FIG. 5, the electrification control unit may control various devices of the vehicle in connection with media factors to change the pulse width and period of a waveform such that the driver feels tactile sensations with respect to percussion, being hit, explosion, and the like. In this case, the waveform may be a square wave.

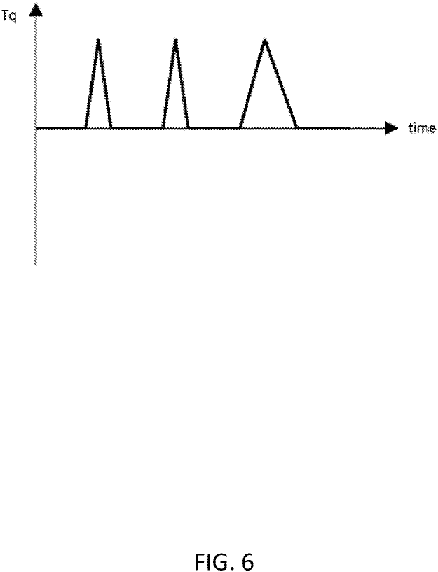

As shown in FIG. 6, the electrification control unit may control various devices of the vehicle in connection with media factors to change the period of a waveform such that the driver feels tactile sensation with respect to cold or the like. In this case, the waveform may be a triangular wave.

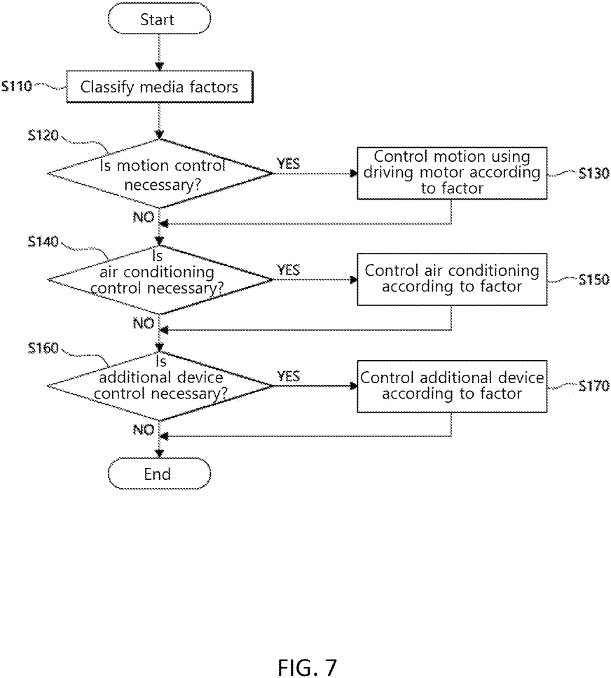

FIG. 7 is a flowchart showing an operation flow of the electrification control unit according to an embodiment of the present disclosure.

Referring to FIG. 7, the electrification control unit 240 (refer to FIG. 3) may analyze media factors reproduced in the electrified vehicle when the autonomous driving mode is set by the driver while the electrified vehicle is traveling.

That is, upon determining that the autonomous driving mode is activated, the electrification control unit 240 (refer to FIG. 3) may analyze media factors reproduced in the electrified vehicle and classify the same into one or more control signals based on analyzed result values (S110). A control signal may be referred to as a 4D control signal. The one or more control signals may include first to third control signals.

The first control signal may be a signal related to motion control, the second control signal may be a signal related to temperature, and the third control signal may be a signal related to factors other than motion control and temperature.

When the first control signal is detected based on the analyzed result values, the electrification control unit 240 (refer to FIG. 3) may determine that motion control is necessary (S120). If motion control is necessary as a result of the determination, the electrification control unit 240 (refer to FIG. 3) may control motion by operating the motion device (S130). For example, the electrification control unit 240 (refer to FIG. 3) may provide various tactile sensations to the driver by setting vibrations differently using the driving motor.

When the second control signal is detected based on the analyzed result values, the electrification control unit 240 (refer to FIG. 3) may determine that air conditioning control is necessary (S140). If air conditioning control is necessary as a result of determination, the electrification control unit 240 (refer to FIG. 3) may control temperature by operating the air conditioning device (S150). For example, the electrification control unit 240 (refer to FIG. 3) may provide various tactile sensations to the driver by setting different temperatures or fan strengths using an air conditioner or a heater.

When the third control signal is sensed based on the analyzed result values, the electrification control unit 240 (refer to FIG. 3) may determine that additional function control is necessary (S160). If additional function control is necessary as a result of determination, the electrification control unit 240 (refer to FIG. 3) may operate the additional device to control a seat or the like (S170). For example, the electrification control unit may provide various tactile sensations to the driver by setting different seat angles using an electric seat.

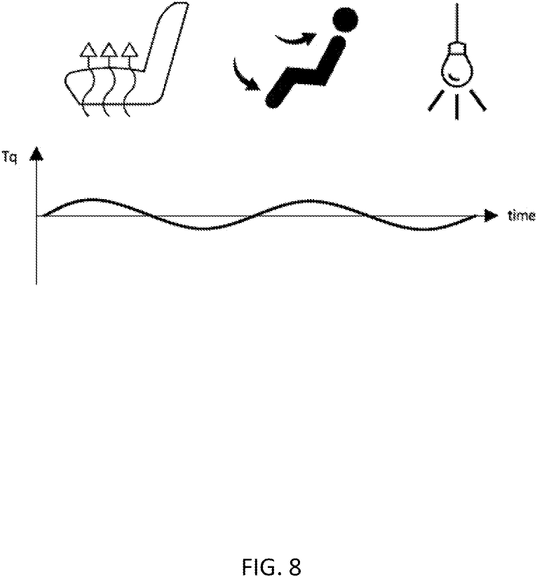

FIG. 8 is a diagram for describing an example of controlling the electrification control unit according to an embodiment of the present disclosure.

Referring to FIG. 8, the electrification control unit may analyze media factors reproduced when the autonomous driving mode is activated and control various devices of the vehicle using first to third control signals based on analyzed result values.

When a hot area, a desert, sunlight, or the like is detected from a media factor, the electrification control unit may control the additional device to operate the heated seat using the third signal and control the air conditioner to operate the heater using the second signal, thereby expressing dryness and hot wind.

Here, the electrification control unit may control the motion device such that a slow sine wave torque is applied using the first signal, thereby expressing heat sufficient to feel dizzy and at the same time causing the driver to feel nauseous.

In addition, the electrification control unit may express glare by controlling the additional device to operate the interior lights using the third signal.

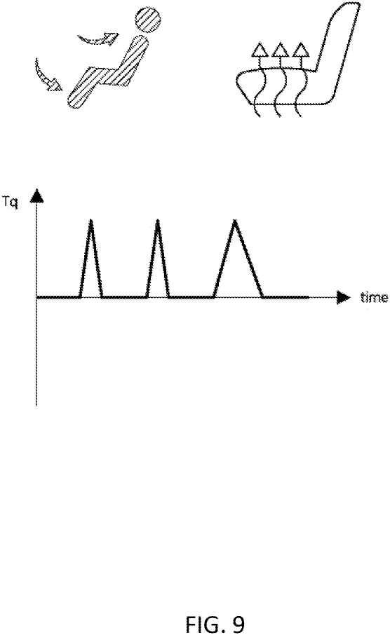

FIG. 9 is a diagram for describing another example of controlling the electrification control unit according to an embodiment of the present disclosure.

Referring to FIG. 9, the electrification control unit may analyze media factors reproduced when the autonomous driving mode is activated and control various devices of the vehicle by using the first to third control signals based on analyzed result values.

When winter, a cold area, cold wind, or the like is detected in a media factor, the electrification control unit may control the additional device to operate the ventilation seat using the third signal and control the air conditioning device to operate the air conditioner using the second signal, thereby expressing cold and strong wind. For example, when a strong wind is detected from a media factor, the electrification control unit may control the air conditioning device to output high air flow.

Here, the electrification control unit can sensibly express sharpness of cold by controlling the motion device such that a triangular wave torque is applied using the first signal.

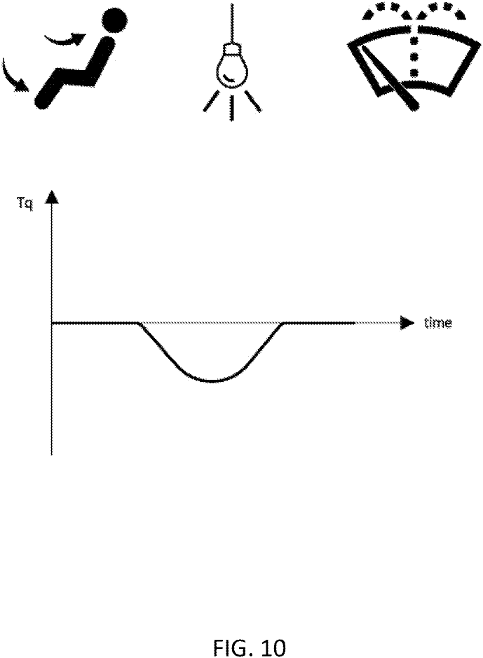

FIG. 10 is a diagram for describing another example of controlling the electrification control unit according to an embodiment of the present disclosure.

Referring to FIG. 10, the electrification control unit may analyze media factors reproduced when the autonomous driving mode is activated and control various devices of the vehicle using the first to third control signals based on analyzed result values.

When explosion is detected from a media factor, the electrification control unit may control the additional device to operate the interior lights or spray washer fluid ejector using the third signal and control the air conditioning device to instantaneously operate the heater using the second signal, thereby expressing flashing, the smell of ethanol, and heat caused by explosion.

Here, the electrification control unit may control the motor device such that an instantaneous deceleration torque (negative half-cycle sine wave torque) is applied using the first signal, thereby expressing tremors due to explosion.

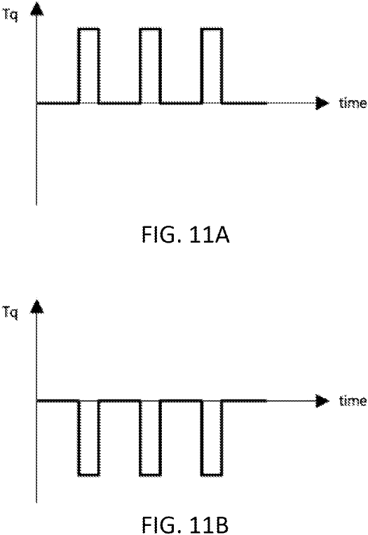

FIG. 11A and FIG. 11B are diagrams for describing another example of controlling the electrification control unit according to an embodiment of the present disclosure.

FIG. 11A is a graph showing a case of percussion, and FIG. 11B is a graph showing a case of being hit.

As shown in FIG. 11A, in case of percussion, the electrification control unit may apply an instantaneous square acceleration torque at percussion timing. In this case, it is possible to express percussion more realistically by increasing the amplitude when a gun has high performance.

On the other hand, as shown in FIG. 11B, in the case of being hit, an instantaneous square deceleration torque may be applied at the moment of being hit. At this time, it is possible to express being hit more realistically by increasing the amplitude in case of a large amount of damage.

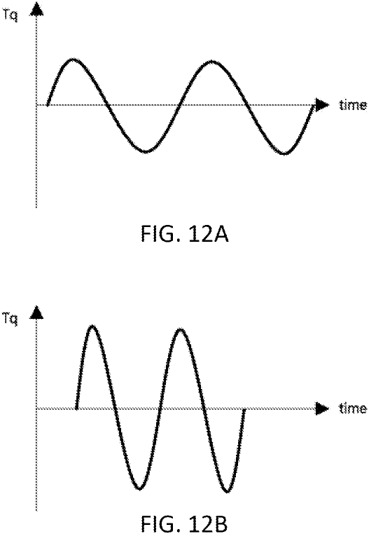

FIG. 12A and FIG. 12B are diagrams for describing another example of controlling the electrification control unit according to an embodiment of the present disclosure.

FIG. 12A is a graph showing a case in which a horse walks, and FIG. 12B is a graph showing a case in which a horse runs.

As shown in FIG. 12A, when a horse walks or runs slowly, a slow sine wave torque with a small amplitude may be applied.

As shown in FIG. 12B, when a horse runs, a fast sine wave torque with a large amplitude can be applied.

As described above, the method for controlling an electrified vehicle in accordance with media according to an embodiment of the present disclosure can implement a 4D function by operating various devices of the vehicle in connection with media when the autonomous driving mode is activated, thereby providing a richer mobility experience to a user.

Although the present disclosure has been described above focusing on the autonomous driving mode, the present disclosure is not limited thereto.

The present disclosure can be equally applied as described above with reference to FIGS. 1 to 12 even when the electrified vehicle is activated in the car camping mode.

The above-described present disclosure can be realized as computer-readable code in a medium in which a program is recorded. Computer-readable media include all kinds of recording devices in which data readable by computer systems is stored. Examples of computer-readable media include a hard disk drive (HDD), a solid state drive (SSD), a silicon disk drive (SDD), a ROM, a RAM, a CD-ROM, a magnetic tape, a floppy disk, an optical data storage device, etc.

Therefore, the above detailed description is to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. An electrification control unit for an electrified vehicle,
wherein the electrification control unit is configured to:
classify media factors of a media content played in an electrified vehicle into one or more control signals; and
control the electrified vehicle in connection with the one or more classified control signals during an autonomous driving mode.

2. The electrification control unit for an electrified vehicle according to claim 1,
wherein the one or more control signals include:
a first control signal related to motion of the electrified vehicle,
a second control signal related to air conditioning, and
a third control signal related to at least one of: seats, interior lights, and/or a washer fluid ejector.

3. The electrification control unit for an electrified vehicle according to claim 2, wherein the electrification control unit includes:
a motion determination unit configured to control a motion device of the electrified vehicle according to the first control signal;
an air conditioning control unit configured to control an air conditioning device of the electrified vehicle according to the second control signal; and
an auxiliary control unit configured to control at least one of: the seats, the interior lights, and/or the washer fluid ejector according to the third control signal.

4. The electrification control unit for an electrified vehicle according to claim 3, wherein the motion determination unit is configured to control the motion device to set vibration differently based on the first control signal.

5. The electrification control unit for an electrified vehicle according to claim 4,
wherein the vibration includes a sine wave, a triangular wave or a square wave, and at least one of: a period, an amplitude, a pulse width, and/or a waveform of the sine wave,
wherein the triangular wave or the square wave is set based on the first control signal.

6. The electrification control unit for an electrified vehicle according to claim 3, wherein the electrification control unit is configured to control one or more of the motion determination unit, the air conditioning control unit, and/or the auxiliary control unit simultaneously or sequentially.

7. A method for controlling an electrification control unit for an electrified vehicle, the method comprising:
determining whether an electrified vehicle is in an autonomous driving mode;
classifying media factors of a media content played in the electrified vehicle into one or more classified control signals if the electrified vehicle is in the autonomous driving mode; and
controlling the electrified vehicle in connection with the one or more classified control signals.

8. The method according to claim 7, wherein the one or more control signals include: a first control signal related to motion of the electrified vehicle, a second control signal related to air conditioning, and a third control signal related to at least one of: seats, interior lights, and/or a washer fluid ejector.

9. The method according to claim 8, wherein the controlling of the electrified vehicle step further comprises:
controlling a motion device of the electrified vehicle according to the first control signal;
controlling an air conditioning device of the electrified vehicle according to the second control signal; and
controlling at least one of: the seats, the interior lights, and/or the washer fluid ejector according to the third control signal.

10. The method according to claim 9, wherein the controlling of the motion device step further includes:
controlling the motion device to set vibration differently based on the first control signal.

11. The method according to claim 10,
wherein the vibration includes a sine wave, a triangular wave or a square wave, and at least one of: a period, an amplitude, a pulse width; and
wherein a waveform of the sine wave, the triangular wave or the square wave is set based on the first control signal.

12. The method according to claim 11, wherein the controlling of the motion device step further includes controlling one or more of: the motion determination unit, the air conditioning control unit, and/or the auxiliary control unit simultaneously or sequentially.

13. A non-transitory computer-readable recording medium in which a program containing computer executable code stored thereon for executing the method of claim 7 is recorded.

14. A vehicle comprising an electrification control unit, wherein the electrification control unit is configured to:
classify media factors of a media content played in an electrified vehicle into one or more control signals; and
control the electrified vehicle in connection with the one or more classified control signals during an autonomous driving mode.
